(19) United States
(12) Patent Application Publication
(10) Pub. No.: US 2014/0311109 A1
(43) Pub. Date: Oct. 23, 2014

(54) PUSH LOCK DIFFERENTIAL PRESSURE SENSOR

(71) Applicant: Nick A. Cicone, Rochester Hills, MI (US)

(72) Inventor: Nick A. Cicone, Rochester Hills, MI (US)

(21) Appl. No.: 13/865,563

(22) Filed: Apr. 18, 2013

(51) Int. Cl. B01D 46/00

(52) U.S. Cl. CPC B01D 46/0005
USPC 55/495

(57) ABSTRACT

A diesel particulate filter is provided and may include a filter housing having an inlet and an outlet and a filter element disposed within the filter housing. A first metal conduit may be in fluid communication with an interior of the filter housing between the inlet and the filter element and a second metal conduit may be in fluid communication with the interior of the filter housing between the filter element and the outlet. A sensor assembly including a sensor housing may have a first port receiving the first metal conduit and a second port receiving the second metal conduit.

### FIELD

The present disclosure relates to diesel particulate filters and more particularly to a sensor arrangement for use with a diesel particulate filter.

### BACKGROUND

Diesel particulate filters are used in conjunction with diesel engines to remove diesel particulate matter or soot from exhaust gas of the diesel engine. Such filters typically include a filter element disposed within a filter housing having an inlet and an outlet. The filter element collects particulate matter as exhaust gas from the diesel engine flows through the housing between the inlet and the outlet.

Filter elements may be formed from cordierite, silicon carbide (SiC), fibrous ceramic, or woven metal fibers. Regardless of the particular construction of the filter element, filter elements may be subjected to a regeneration process that burns off accumulated particulate—either passively through use of a catalyst or actively through use of a burner. Burning off accumulated particulate matter prevents the filter element from becoming clogged and, as a result, allows the filter element to collect a desired amount of particulate matter throughout the life of the diesel engine.

A pressure sensor is conventionally used in conjunction with a diesel particulate filter to determine a pressure drop across the filter element. For example, a pressure sensor may be used to measure a pressure proximate to the inlet of the housing and may be used to measure a pressure proximate to the outlet of the housing. The pressure measurement taken proximate to the inlet and the pressure measurement taken proximate to the outlet may be compared to determine a pressure drop across the filter element.

The foregoing comparison provides an indirect measurement of the amount of particulate matter disposed on the filter element by determining how much exhaust is flowing through the filter element. When the pressure drop exceeds a predetermined amount, for example, the filter element is deemed to be clogged and a regeneration process is performed to remove particulate matter from the filter element. In so doing, flow through the filter element is restored to a desired level and the filter element is permitted to once again collect a desired amount of particulate matter from the exhaust gas flowing through the housing.

While conventional sensors adequately measure a pressure drop across a filter element of a diesel particulate filter, such sensors typically require extensive hardware to mount the sensor to or remotely from a housing of the diesel particulate filter. Further, such sensors are typically coupled to ports of the diesel particulate filter via flexible hoses or tubes to facilitate installation of the sensor. Such tubes adequately provide fluid communication between the sensor and an interior of the filter housing, but add to the overall cost and complexity of the system.

### SUMMARY

A diesel particulate filter is provided and may include a filter housing having an inlet and an outlet and a filter element disposed within the filter housing. A first metal conduit may be in fluid communication with an interior of the filter housing between the inlet and the filter element and a second metal conduit may be in fluid communication with the interior of the filter housing between the filter element and the outlet. A sensor assembly including a sensor housing may have a first port receiving the first metal conduit and a second port receiving the second metal conduit.

In another configuration, a diesel particulate filter is provided and may include a filter housing having an inlet, an outlet, and a longitudinal axis extending between the inlet and the outlet and a filter element disposed within the filter housing. A first conduit may be in fluid communication with an interior of the filter housing between the inlet and the filter element, whereby the first conduit includes a first portion extending substantially parallel to the longitudinal axis and a second portion formed substantially ninety degrees (90°) relative to the first portion. A second conduit may be in fluid communication with the interior of the filter housing between the filter element and the outlet, whereby the second conduit includes a third portion extending substantially parallel to the longitudinal axis and a fourth portion formed substantially ninety degrees (90°) relative to the third portion. A sensor assembly including a sensor housing may have a first port receiving the second portion of the first conduit and a second port receiving the fourth portion of the second conduit.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of a diesel particulate filter incorporating a sensor assembly in accordance with the principles of the present disclosure;

FIG. 2 is a partial perspective view of the diesel particulate filter of FIG. 1 showing a front view of the sensor assembly of FIG. 1;

FIG. 3 is a partial perspective view of the diesel particulate filter of FIG. 1 showing a rear view of the sensor assembly of FIG. 1;

FIG. 4 is a partial perspective view of the diesel particulate filter of FIG. 1 showing a top view of the sensor assembly of FIG. 1;

FIG. 5 is a cross-sectional view of a portion of the sensor assembly of FIG. 2 taken along line 5-5 of FIG. 2; and

FIG. 6 is a cross-sectional view of an alternate sensor for use with the diesel particulate filter of FIG. 1.

### DETAILED DESCRIPTION

With reference to the figures, a diesel particulate filter 10 is provided. The diesel particulate filter 10 may be used in conjunction with a sensor assembly 12 that measures a pressure drop across the diesel particulate filter 10. The sensor assembly 12 may work in conjunction with the diesel particulate filter 10 to ensure that the diesel particulate filter 10 removes a desired amount of particulate matter from an exhaust gas of a diesel engine (not shown) during operation thereof.

The diesel particulate filter 10 may include a filter housing 14 and a filter element 16. The filter housing 14 may include an inlet 18, an outlet 20, and an inner volume 22. The inlet 18 may be disposed at an opposite end of the filter housing 14 than the outlet 20 and may receive exhaust gas from a diesel engine (not shown) located upstream of the inlet 18. The exhaust gas from the diesel engine may be received by the inner volume 22 of the filter housing 14 via the inlet 18.

The filter element 16 may be disposed within the inner volume 22 of the filter housing 14 and may be located along a longitudinal axis 24 of the filter housing 14. The filter element 16 may be disposed within the inner volume 22 between the inlet 18 and the outlet 20 such that exhaust gas received at the inlet 18 flows through the filter element 16 prior to being expelled from the filter housing 14 at the outlet 20. The filter element 16 may be formed from cordierite, silicon carbide (SiC), fibrous ceramic, or woven metal fibers. Accordingly, a regeneration process may be used in conjunction with the filter element 16 to remove accumulated particulate matter collected by the filter element 16. Performing a regeneration process on the filter element 16 ensures that particulate matter collected by the filter element 16 is burned off to ensure a desired flow of exhaust gas through the filter element 16.

The filter housing 14 may additionally include a first port 26 and a second port 28 that are both formed through the filter housing 14 and are in fluid communication with the inner volume 22. The first port 26 may be located between the inlet 18 and the filter element 16 while the second port 28 may be located between the filter element 16 and the outlet 20.

The sensor assembly 12 may be attached to the filter housing 14 and may include a sensor module 30, a first conduit 32, and a second conduit 34. The sensor module 30 may include a first port 36 and a second port 38. The first port 36 and the second port 38 may be in fluid communication with a body 40 of the sensor module 30 and may likewise be in fluid communication with the first conduit 32 and the second conduit 34, respectively. The body 40 may include a pressure sensor 42 disposed therein that measures a pressure of the fluid supplied to the body 40 via the first port 36 and the second port 38.

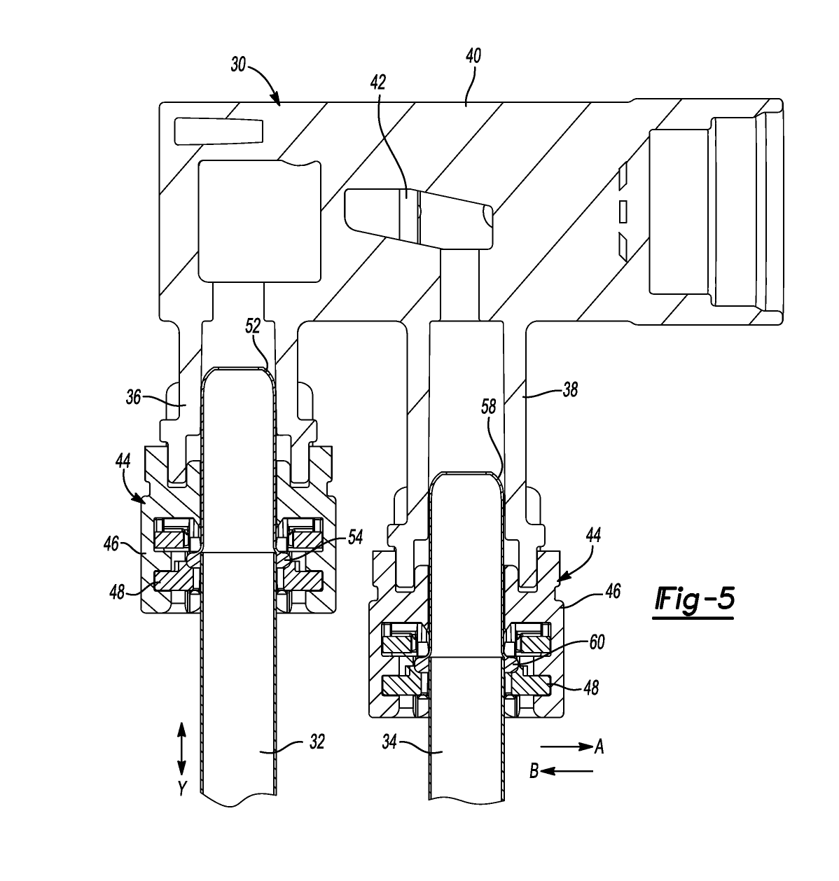

The first port 36 may extend from the body 40 to a lesser extent than the second port 38, as shown in FIG. 5. Each of the first port 36 and the second port 38 may include a connector assembly 44 attached to a distal end of each port 36, 38. In one configuration, the connector assembly 44 is a so-called “quick-connect” assembly having a housing 46 and a locking element 48 that cooperate to attach the first conduit 32 and the second conduit 34 to the first port 36 and the second port 38, respectively. Specifically, the locking element 48 may be supported by the connector assembly 44 between a locked state (FIG. 5) and an unlocked state (not shown). The locking element 48 may be biased into the locked state and may be formed from a flexible material such as, for example, plastic, that permits the locking element 48 to be selectively moved from the locked state to the unlocked state.

Forming the locking element 48 from a flexible material allows the locking element 48 to be biased into the locked state such that when a force applied to the locking element 48 is released, the locking element 48 is automatically returned to the locked state due to the elastic material of the locking element 48. In other words, forming the locking element 48 from a flexible material such as plastic allows the locking element 48 to be moved from the locked state (FIG. 5) in a direction (A) and, subsequently, be automatically returned to the locked state by moving in a direction (B) that is opposite to the direction (A).

The first conduit 32 may be formed from metal and may include a first end 50 attached to and in fluid communication with the first port 26 of the filter housing 14 and a second end 52 attached to and in fluid communication with the first port 36 of the sensor module 30. The first conduit 32 may additionally include a projection 54 that cooperates with the locking element 48 to retain and position the first conduit 32 relative to and within the first port 36.

The second conduit 34 may likewise be formed from metal and may include a first end 56 attached to and in fluid communication with the second port 28 of the filter housing 14 and a second end 58 attached to and in fluid communication with the second port 38 of the sensor module 30. The second conduit 34 may additionally include a projection 60 that cooperates with the locking element 48 to retain and position the second conduit 34 relative to and within the second port 38.

As described, the first conduit 32 is in fluid communication with the first port 26 of the filter housing 14 and with the first port 36 of the sensor module 30. Accordingly, the first conduit 32 supplies the first port 36 of the sensor module 30 with a supply of exhaust gas disposed between the inlet 18 of the filter housing 14 and the filter element 16. The exhaust gas supplied to the first port 36 of the sensor module 30 may be at a pressure (Pᵢ).

The second conduit 34 is in fluid communication with the second port 28 of the filter housing 14 and is in fluid communication with the second port 38 of the sensor module 30. Accordingly, the second conduit 34 supplies exhaust gas to the sensor module 30 from an area within the filter housing 14 between the filter element 16 and the outlet 20. The pressure of the exhaust gas supplied to the sensor module 30 via the second conduit 34 may be at a pressure (Pₒ).

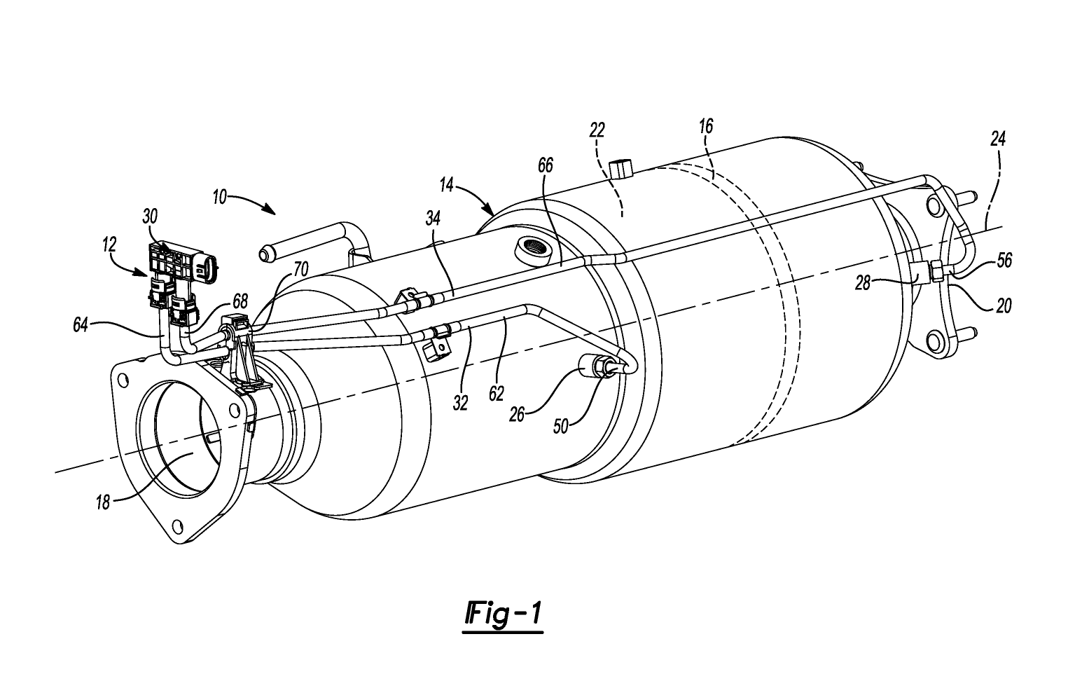

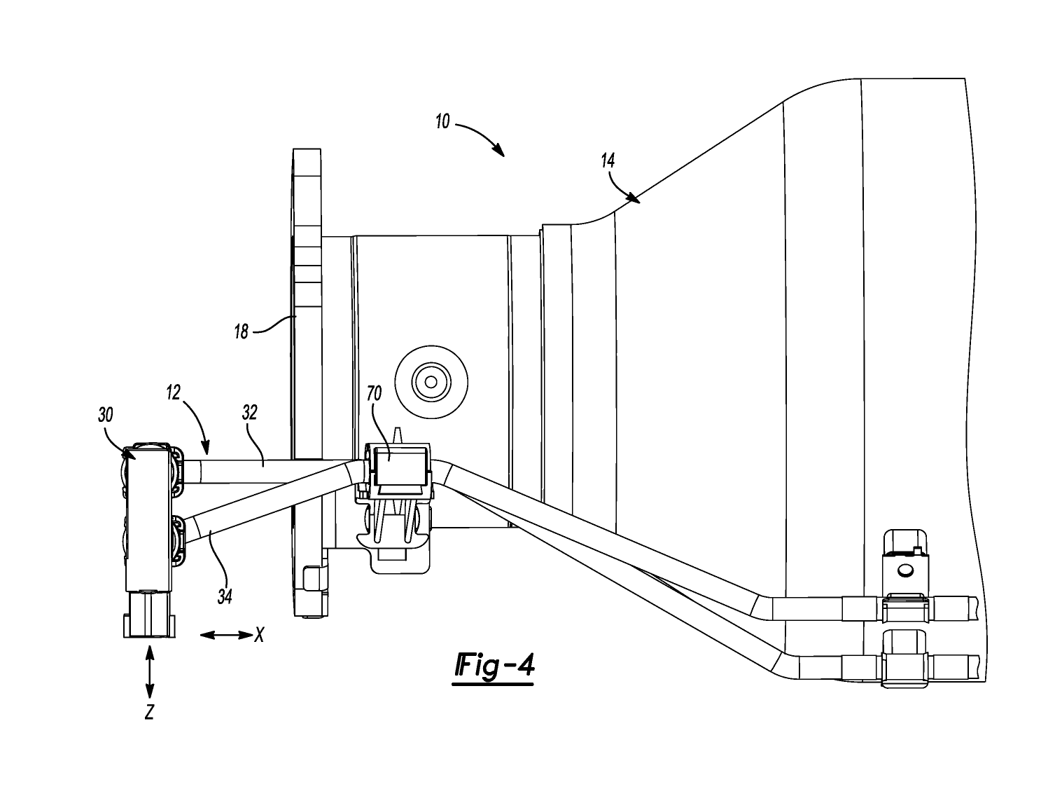

With particular reference to FIGS. 1-5, attachment of the sensor assembly 12 to the diesel particulate filter 10 will be described in detail. The first conduit 32 and the second conduit 34 may initially be attached to the filter housing 14 at the first port 26 and the second port 28, respectively. Following attachment of the first conduit 32 and the second conduit 34 to the first port 26 and the second port 28, respectively, the first conduit 32 and the second conduit 34 may be attached to the sensor module 30.

As shown in FIG. 1, the first conduit 32 may include a first portion 62 and a second portion 64. The first portion 62 may extend substantially parallel to the longitudinal axis 24 of the filter housing 14 while the second portion 64 may extend substantially ninety degrees (90°) relative to the first portion 62. The second conduit 34 may likewise include a first portion 66 and a second portion 68. The first portion 66 may extend substantially parallel to the longitudinal axis 24 of the filter housing 14 and the second portion 68 may be formed substantially ninety degrees (90°) relative to the first portion 66. Accordingly, the second portion 64 of the first conduit 32 and the second portion 68 of the second conduit 34 may extend in a direction substantially away from the filter housing 14 when the first conduit 32 and the second conduit 34 are attached to the filter housing 14.

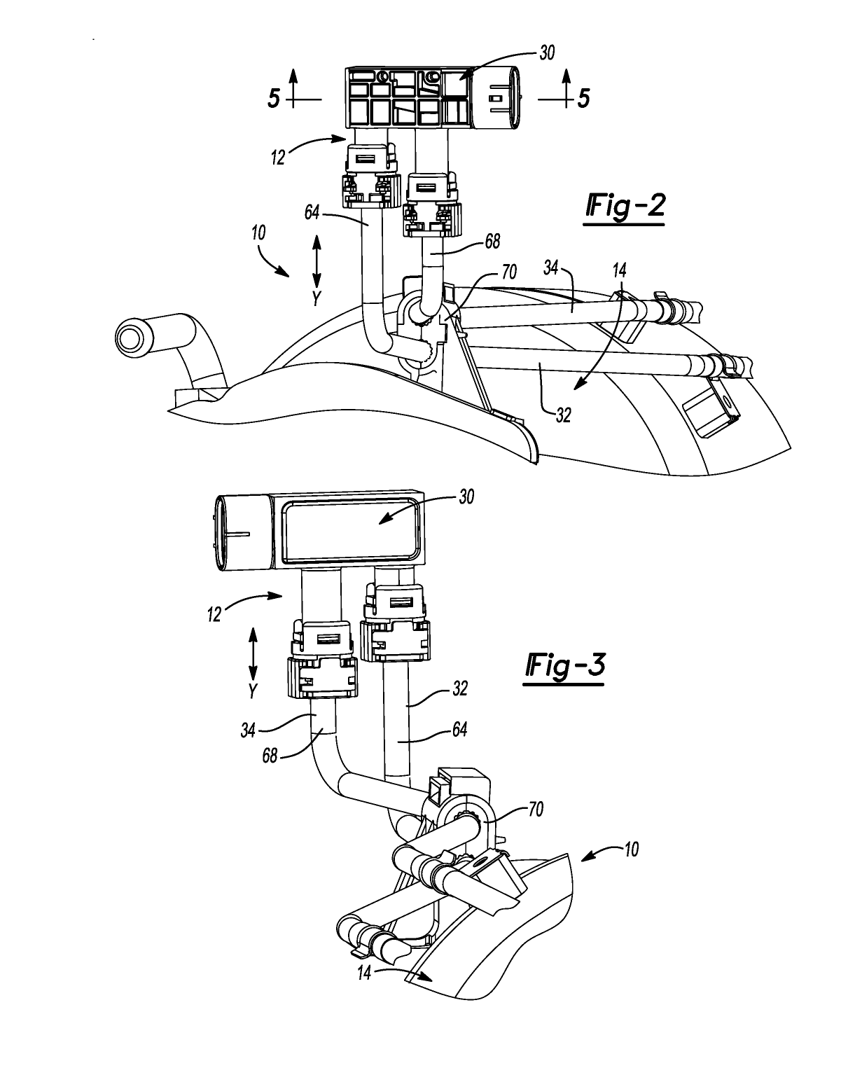

Forming the second portion 64 of the first conduit 32 substantially ninety degrees (90°) relative to the first portion 62 and forming the second portion 68 of the second conduit 34 substantially ninety degrees (90°) relative to the first portion 66 allows the second end 52 of the first conduit 32 and the second end 58 of the second conduit 34 to be moved in virtually any direction, thereby facilitating attachment of the first conduit 32 and the second conduit 34 to the sensor module 30. For example, the second ends 52, 58 of the respective conduits 32, 34 may be moved in the directions (X), (Y), and (Z), as shown in FIGS. 2-5.

Allowing the second ends 52, 58 of the respective conduits 32, 34 to move in the directions (X), (Y), (Z) allows the conduits 32, 34 to be formed from metal and to be directly attached to the sensor module 30 at the second ends 52, 58 of each conduit 32, 34. Namely, allowing movement of the second ends 52, 58 in the directions (X), (Y), (Z) allows the second ends 52, 58 to be easily attached to the sensor module 30 and, further, allows the conduits 32, 34 to account for any manufacturing tolerances in any of the various components associated with the diesel particulate filter 10 and/or the sensor assembly 12 without requiring the conduits 32, 34 to be formed from a flexible material. For example, if the second portion 64 of the first conduit 32 is formed slightly shorter than required, a force may be applied to the first conduit 32 in the direction (Y) to move the second end 52 of the first conduit 32 toward the sensor module 30. Such movement allows the second end 52 to be received within the first port 36 of the sensor module 30 notwithstanding the shorter length of the second portion 64 of the first conduit 32.

During installation of the first conduit 32 and the second conduit 34, a force may be applied in any one or all of the directions (X), (Y), and (Z) to properly position the second ends 52, 58 of the conduits 32, 34 with respect to the respective ports 36, 38 of the sensor module 30. Once the second ends 52, 58 of the conduits 32, 34 are respectively aligned with the first port 36 and the second port 38 in the directions (X) and (Z), a force may be applied to the conduits 32, 34 in the direction (Y) to urge the second ends 52, 58 of the conduits 32, 34 into the respective ports 36, 38 of the sensor module 30.

Upon sufficient movement of the second ends 52, 58 into the ports 36, 38, respectively, the projection 54 of the first conduit 32 and the projection 60 of the second conduit 34 encounters the connector assemblies 44 of the ports 36, 38. Once the second ends 52, 58 are sufficiently received within the respective ports 36, 38, the projections 54, 60 engage the locking elements 48 of the respective connector assemblies 44, thereby moving the locking elements 48 in the direction (A). Movement of the locking elements 48 in the direction (A) moves the locking elements 48 from the locked state (FIG. 5) to an unlocked state. Movement of the locking elements 48 into the unlocked state permits the projections 54, 60 of the respective conduits 32, 34 to move into the connector assemblies 44 and, therefore, allows the second ends 52, 58 to be received within the ports 36, 38, respectively.

Upon sufficient movement of the second ends 52, 58 into the respective ports 36, 38, the projections 54, 60 pass by the locking elements 48, thereby allowing the locking elements 48 to be automatically returned to the locked state by moving in the direction (B). As shown in FIG. 5, movement of the locking elements 48 in the direction (B) returns the locking elements 48 to the locked state, thereby retaining the second ends 52, 58 within the respective ports 36, 38 due to engagement between the projections 54, 60 of the conduits 32, 34 and the locking elements 48 of the connector assemblies 44. Accordingly, the first conduit 32 and the second conduit 34 are automatically positioned and retained within the first port 36 and the second port 38, respectively, upon sufficient movement of the second ends 52, 58 into the respective ports 36, 38.

Once the first conduit 32 and the second conduit 34 are attached to the first port 36 and the second port 38, respectively, a support bracket 70 may be used to attach the conduits 32, 34 to the filter housing 14. In addition, the support bracket 70 may fix a relative position of the first conduit 32 and the second conduit 34, thereby preventing relative movement between the first conduit 32 and the second conduit 34 once the first conduit 32 and the second conduit 34 are attached to the sensor module 30. In one configuration, the first conduit 32 and the second conduit 34 include a projection (not shown). The projections may be similar to the projections 54, 60 and may engage the support bracket 70 to restrict movement of the first conduit 32 and the second conduit 34 relative to the support bracket 70.

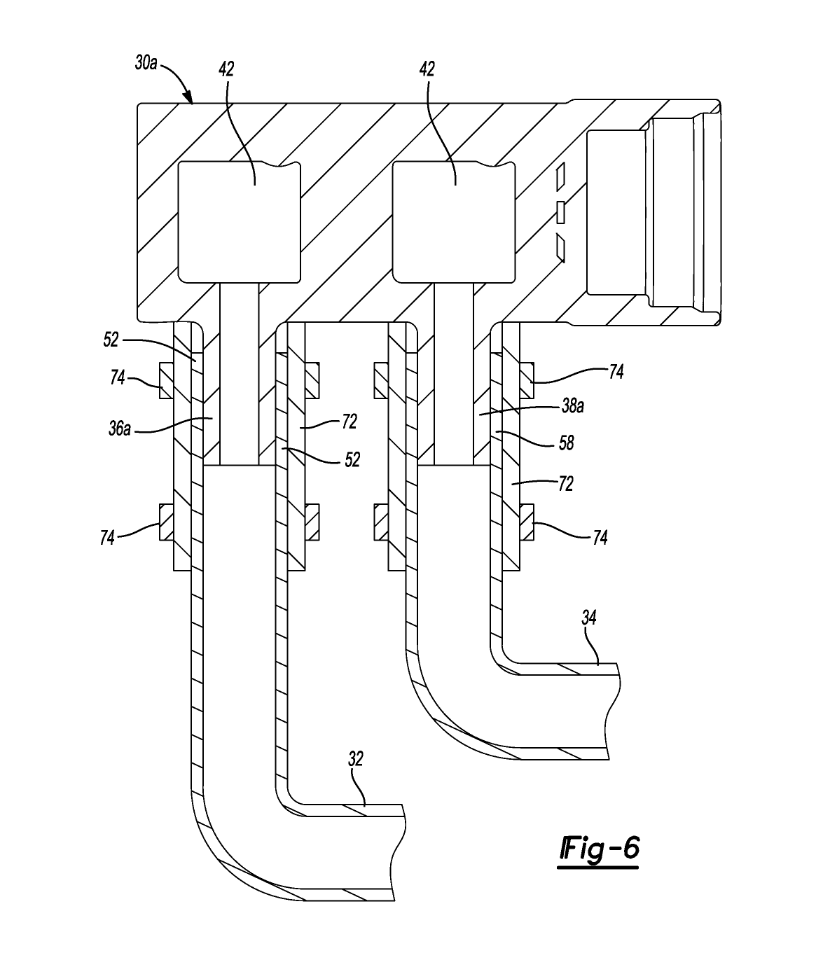

While the sensor module 30 is described as including a first port 36 and a second port 38, each including a connector assembly 44, both of the ports 36, 38 could include an alternate construction. For example, one or both of the ports 36, 38 may include the configuration shown in FIG. 6. In view of the substantial similarity in structure and function of the components associated with the sensor module 30 with respect to the sensor module 30a, like reference numerals are used hereinafter and in the drawings to identify like components while like reference numerals containing letter extensions are used to identify those components that have been modified.

The sensor module 30a shown in FIG. 6 may include a pair of ports 36a, 38a that directly receive the second ends 52, 58 of the first conduit 32 and the second conduit 34, respectively. Specifically, one of the ends 52, 58 of the conduits 32, 34 may be received about the port 36a, 38a and may be secured thereto via a sleeve 72 and one or more clamps 74. In one configuration, the sleeve 72 may be formed from an elastomeric material such as, for example, rubber, and may axially surround the ends 52, 58 of the respective conduits 32, 34. Once the sleeve 72 is received about the ends 52, 58 of the conduits 32, 34, the clamps 74 may be secured around the sleeve 72 to attach the sleeve 72 to the conduits 32, 34. Such attachment of the clamp 74 to the sleeve 72 compresses the sleeve 72 about the second ends 52, 58 of the conduits 32, 34, thereby constricting the ends 52, 58 about the respective ports 36a, 38a of the sensor module 30a.

With particular reference to FIGS. 1-5, operation of the diesel particulate filter 10 and sensor assembly 12 will be described in detail. While the sensor module 30 may include the sensor module 30 shown in FIG. 5 or the sensor module 30a shown in FIG. 6, the sensor assembly 12 will be described and shown hereinafter as including the sensor module 30 shown in FIG. 5.

During operation of a diesel engine, exhaust gas produced by the diesel engine is received by the inlet 18 of the filter housing 14. The exhaust gas flows into the inner volume 22 of the filter housing 14 at the inlet 18 and encounters the filter element 16 disposed within the inner volume 22. The filter element 16 receives the exhaust gas and removes particulate matter and soot from the exhaust gas prior to the exhaust gas being expelled from the filter housing 14 at the outlet 20.

During operation of the diesel particulate filter 10, the sensor assembly 12 monitors the pressure of the exhaust gas upstream of the filter element 16 and downstream of the filter element 16 to ensure a desired volume of exhaust gas passes through the filter element 16. Specifically, the first conduit 32 extracts a volume of exhaust gas from the filter housing 14 generally between the inlet 18 and the filter element 16 at the first port 26. Likewise, the second conduit 34 extracts a volume of exhaust gas from the inner volume 22 of the filter housing 14 generally between the filter element 16 and the outlet 20. The exhaust gas extracted by the first conduit 32 is at the pressure (Pᵢ) and the exhaust gas extracted by the second conduit 34 is at the pressure (Pₒ).

The exhaust gas extracted by the first conduit 32 is directed to the sensor module 30 and is received by the sensor module 30 at the first port 36. Likewise, the exhaust gas extracted by the second conduit 34 is directed to the sensor module 30 and is received by the sensor module 30 at the second port 38. The exhaust gas received by the sensor module 30 from the first conduit 32 and the second conduit 34 are measured by the pressure sensor 42 disposed within the body 40 of the sensor module 30. Specifically, the pressure (Pᵢ) is compared to the pressure (Pₒ) to determine a pressure drop across the filter element 16.

If the pressure drop across the filter element 16 is within a predetermined acceptable range, a controller (not shown) may determine that the flow of exhaust gas through the filter element 16 is acceptable. Conversely, if the pressure drop across the filter element 16 exceeds a predetermined value, the controller element may determine that the filter element 16 is clogged and, as a result, is incapable of extracting a desired amount of particulate matter from the exhaust gas. At this point, the controller may perform a regeneration process to burn off particulate matter contained within the filter element 16, thereby allowing the filter element 16 to once again extract a desired amount of particulate matter and soot from the exhaust gas.

What is claimed is:

1. A diesel particulate filter comprising:
a filter housing having an inlet and an outlet;
a filter element disposed within said filter housing;
a first metal conduit in fluid communication with an interior of said filter housing between said inlet and said filter element;
a second metal conduit in fluid communication with said interior of said filter housing between said filter element and said outlet; and
a sensor assembly including a sensor housing having a first port receiving said first metal conduit and a second port receiving said second metal conduit.

2. The diesel particulate filter of claim 1, further comprising a first fitting connecting said first metal conduit to said sensor housing and a second fitting connecting said second metal conduit to said sensor housing.

3. The diesel particulate filter of claim 2, wherein said first metal conduit includes a first projection received by said first fitting and said second metal conduit includes a second projection received by said second fitting.

4. The diesel particulate filter of claim 3, wherein said first projection is attached to said first fitting via a snap-fit and said second projection is attached to said second fitting via a snap-fit.

5. The diesel particulate filter of claim 4, wherein said first projection engages a first locking feature of said first fitting when said first metal conduit is inserted into said first fitting a first predetermined distance and said second projection engages a second locking feature of said second fitting when said second metal conduit is inserted into said second fitting a second predetermined distance.

6. The diesel particulate filter of claim 2, wherein said first metal conduit is automatically connected to said first fitting when said first metal conduit is inserted into said first fitting a first predetermined distance and said second metal conduit is automatically connected to said second fitting when said second metal conduit is inserted into said second fitting a second predetermined distance.

7. The diesel particulate filter of claim 1, wherein said first metal conduit includes a first portion extending substantially parallel to a longitudinal axis of said filter housing and a second portion extending substantially ninety degrees (90°) relative to said first portion, said second portion received by said sensor housing.

8. The diesel particulate filter of claim 7, wherein said second metal conduit includes a third portion extending substantially parallel to said longitudinal axis of said filter housing and a fourth portion extending substantially ninety degrees (90°) relative to said third portion, said fourth portion received by said sensor housing.

9. The diesel particulate filter of claim 8, further comprising a support receiving said first portion of said first metal conduit and said third portion of said second metal conduit to fix a relative position of said first metal conduit and said second metal conduit.

10. The diesel particulate filter of claim 9, wherein said support is attached to said filter housing such that said second portion of said first metal conduit and said fourth portion of said second metal conduit extend in a direction away from said filter housing.

11. A diesel particulate filter comprising:
a filter housing having an inlet, an outlet, and a longitudinal axis extending between said inlet and said outlet;
a filter element disposed within said filter housing;
a first conduit in fluid communication with an interior of said filter housing between said inlet and said filter element, said first conduit including a first portion extending substantially parallel to said longitudinal axis and a second portion formed substantially ninety degrees (90°) relative to said first portion;
a second conduit in fluid communication with said interior of said filter housing between said filter element and said outlet, said second conduit including a third portion extending substantially parallel to said longitudinal axis and a fourth portion formed substantially ninety degrees (90°) relative to said third portion; and
a sensor assembly including a sensor housing having a first port receiving said second portion of said first conduit and a second port receiving said fourth portion of said second conduit.

12. The diesel particulate filter of claim 11, further comprising a first fitting connecting said first conduit to said sensor housing and a second fitting connecting said second conduit to said sensor housing.

13. The diesel particulate filter of claim 12, wherein said first conduit includes a first projection received by said first fitting and said second conduit includes a second projection received by said second fitting.

14. The diesel particulate filter of claim 13, wherein said first projection is attached to said first fitting via a snap-fit and said second projection is attached to said second fitting via a snap-fit.

15. The diesel particulate filter of claim 14, wherein said first projection engages a first locking feature of said first fitting when said first conduit is inserted into said first fitting a first predetermined distance and said second projection engages a second locking feature of said second fitting when said second conduit is inserted into said second fitting a second predetermined distance.

16. The diesel particulate filter of claim 12, wherein said first conduit is automatically connected to said first fitting when said first conduit is inserted into said first fitting a first predetermined distance and said second conduit is automatically connected to said second fitting when said second conduit is inserted into said second fitting a second predetermined distance.

17. The diesel particulate filter of claim 11, wherein said first portion of said first conduit and said second portion of said first conduit are formed from metal.

18. The diesel particulate filter of claim 17, wherein said third portion of said second conduit and said fourth portion of said second conduit are formed from metal.

19. The diesel particulate filter of claim 11, further comprising a support receiving said first portion of said first conduit and said third portion of said second conduit to fix a relative position of said first conduit and said second conduit.

20. The diesel particulate filter of claim 19, wherein said support is attached to said filter housing such that said second portion of said first conduit and said fourth portion of said second conduit extend in a direction away from said filter housing.
